(19) United States
(12) Patent Application Publication
(10) Pub. No.: US 2005/0218906 A1
(43) Pub. Date: Oct. 6, 2005

(54) System and method for monitoring of insulation condition

(76) Inventors: Abdelkrim Karim Younsi, Ballston Lake, NY (US); Gerald Burt Kliman, Niskayuna, NY (US); Edith M. Kliman, Niskayuna, NY (US); Manoj Ramprasad Shah, Latham, NY (US); Sang Bin Lee, Schenectady, NY (US); Michael Brynn House, Clifton Park, NY (US); Roderick Mark Lusted, Niskayuna, NY (US)

Correspondence Address: Patrick S. Yoder;FLETCHER YODER, P.O. Box 692289, Houston, TX, 77269-2289, US

(21) Appl. No.: 10/814,839

(22) Filed: Mar. 31, 2004

(51) Int. Cl. H02H 3/00; H02H 9/08; H01H 31/12

(52) U.S. Cl. 324/551

(57) ABSTRACT

An online insulation condition monitoring system for a rotating electric machine, includes a differential current sensor and a voltage sensor coupled to the machine, for measuring values for the instantaneous differential current and the instantaneous phase voltage respectively. A processing module is configured for converting the values for the instantaneous differential current and the instantaneous phase voltage to respective values for phasor current and phasor voltage. The processing module further calculates an angular relationship between phasor current and phasor voltage and generates an output based on the calculated angular relationship, as an indication of insulation condition.

### BACKGROUND

The present invention relates to insulation condition monitoring, and more specifically to a technique for monitoring of the state of insulation, such as for stator winding insulation condition monitoring.

Many different types of electrical machines employ windings and other conductors that are insulated by various insulation systems. For example, motors and generators commonly include wound rotors and stators, or may include preformed windings or coils. The conductors typically serve either simply to conduct electrical current, or to produce magnetic fields by virtue of the flow of such current. Insulation systems separate conductors and windings from one another, and from adjacent components in the assembled system. Such insulation systems may include various varnish systems, tapes, coatings, sleeves, and so forth, or combinations of these. The integrity of the insulation systems is important to the reliability and life expectancy of the electrical equipments in which they are installed.

Insulating systems may break down for many reasons, jeopardizing the continued operation of electrical equipment. The winding insulation, for example, for electric machines is subject to damage and deterioration caused by thermal, electrical, mechanical, chemical and environmental stresses. Typical insulation failure occurs in the slot section between turns or between the coil and ground, and at end windings between coils of adjacent phases. Winding insulation degradation can result in acceleration of machine failure, which decreases the service life of the machine and results in increased costs due to repair or replacement cost and loss of revenue due to machine outage. Therefore it is desirable to monitor the insulation condition for scheduling repair or replacement of winding insulation to prevent such a failure, or at least to anticipate when maintenance or service may become in order.

Off line methods for evaluating the insulation condition include over-voltage hi-pot or high voltage ramp tests, insulation resistance or polarization index tests, surge tests, dissipation factor tests, also known as “tan delta” or power factor tests, and off-line partial discharge tests. Such tests have been extensively used and accepted over many years in providing the condition of the winding insulation. However, these conventional off-line techniques can be intrusive and costly since it is required that the electrical machine be shut down and taken out of service to perform the required diagnostic test and/or measurement. The regular machine maintenance is typically performed once every 3-6 years; therefore, the off-line stator insulation condition cannot be evaluated frequently enough to guarantee reliable operation of the machine until the next outage.

Several on-line measurement techniques are also available for monitoring the winding insulation condition. These include vibration measurement and monitoring, temperature measurement, and differential current measurement. One major drawback of these methods is that the monitoring system detects severe fault conditions only after the fault has occurred, making proactive maintenance and servicing difficult. The on-line partial discharge detects early symptoms of insulation degradation; however, it requires expensive specialized equipment and accurate interpretation of the measurements relies on the skill of an operator.

Accordingly, there is a need for a low cost, simple, and reliable on-line solution for assessing the groundwall insulation condition.

### BRIEF DESCRIPTION

Briefly, in accordance with one aspect of the technique, an insulation condition monitoring system is provided for a 3 phase rotating electric machine. The technique may be also used in a single phase rotating electric machine. The system includes a differential current sensor and a voltage sensor coupled to each phase of the machine for measuring the instantaneous differential current and the instantaneous phase voltage, respectively. A processing module is configured for converting the values of the instantaneous differential current and the instantaneous phase voltage to respective phasor quantities, i.e. magnitudes and phase angles. The processing module further calculates an angular relationship between phasor current and phasor voltage and generates an output based on the calculated angular relationship, as an indication of insulation condition.

In accordance with another aspect of the technique, a winding insulation condition monitoring method is provided. The method includes measuring a first set of values for an instantaneous differential current and an instantaneous phase voltage during operation of the rotating machine, and calculating a second set of values for a phasor current and a phasor voltage based upon the first set of values of the instantaneous differential current and the instantaneous phase voltage, respectively. An angular relationship between the phasor current and phasor voltage is calculated and insulation condition is determined based on the angular relationship.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical view of an exemplary insulation condition monitoring system for an electric rotating machine in accordance with aspects of the present techniques;

FIG. 2 is a diagrammatical view of a three phase electric rotating machine instrumented for monitoring of insulation condition via a system of the type shown in FIG. 1

FIG. 3 is a diagrammatical representation of an equivalent, analogous circuit in a system for measuring a phase angle relationship between differential current and phase voltage for one phase of a rotating machine of the type illustrated in FIG. 2;

FIG. 4 is a phasor diagram illustrating a relationship between phasor voltage and differential current for insulation condition monitoring in accordance with aspects of the present technique; and

FIG. 5 is a flow chart illustrating exemplary steps involved in the insulation condition monitoring via a system of the type shown in FIG. 1.

### DETAILED DESCRIPTION

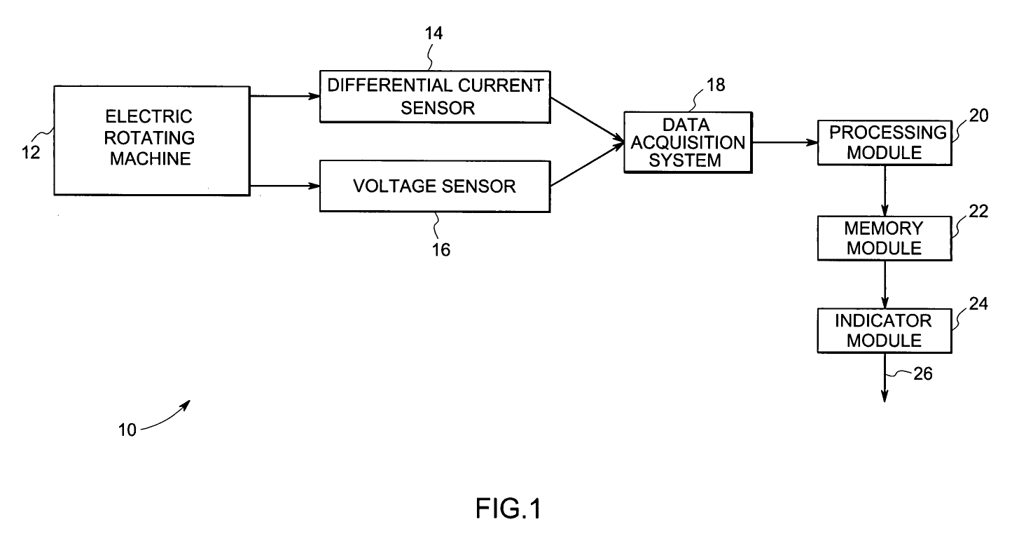

Referring now to FIG. 1, an online insulation condition monitoring system 10 is illustrated for a rotating electric machine 12, which is typically a motor or a generator. The system 10 comprises a differential current sensor 14 and a voltage sensor 16 coupled to the machine 12, for measuring values for the instantaneous differential current and the instantaneous phase voltage respectively. A data acquisition system 18 enables measurement of signals from the output of the differential current sensor 14 and the voltage sensor 16. The signals are digitized at a sampling frequency sufficient for obtaining the phasor quantities.

The signals from the sensors 14 and 16, measured by the data acquisition systeml8, are applied to a processing module 20. Module 20 will typically include hardware circuitry and software for performing computations indicative of insulation condition as described below. Module 20 may thus include a range of circuitry types, such as, a microprocessor based module, and application-specific or general purpose computer, programmable logic controller, or even a logical module or code within such a device. The module 20, is configured to convert the values for the instantaneous differential current and the instantaneous phase voltage to respective values for phasor current and phasor voltage. The processing module 20 fuirther calculates an angular relationship between phasor current and phasor voltage and generates an output based on the calculated angular relationship, as an indication of insulation condition. A memory module 22 is used for storing the output generated from the processing module 20. The same, or a different memory module may also store programming code, as well as parameters and values required for the calculations made by the processing module 20. An indicator module 24 compares the output of the processing module 20 to a predetermined threshold value and generates an indication signal 26 based on the comparison. In general, the indication signal 26 may provide a simple status output, or may be used to activate or set a flag, such as an alert when the output of the processing module 20 exceeds the threshold value, indicating that the insulation is in need of attention or will be in need of attention based upon its current state or a trend in its state.

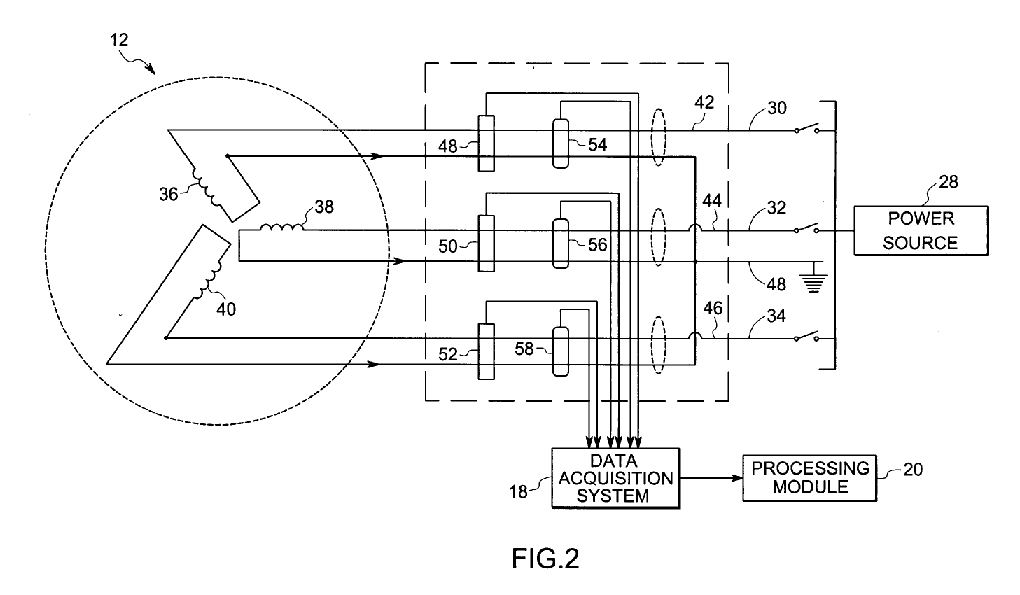

FIG. 2 shows an embodiment of an online insulation condition monitoring system 10 for a three phase electric rotating machine 12. In the illustrated embodiment, a power source 28 is shown for providing power to the machine. In a typical application, the power source 28 may include a power grid directly coupled to the machine, or may include a drive, such as an inverter drive, converter, and so forth. As shown, the source 28 provides 3 phase power, including a first phase 30, a second phase 32 and a third phase 34. Each of the phases provides current to a corresponding winding or group of windings in the machine 12. Thus, in the three phase implementation illustrated, phase 30 is shown coupled to a winding or winding group 36. Second and third phases are shown coupled to similar windings or winding groups 38 and 40, respectively.

The present technique provides for determining the condition of insulation systems of each of the windings or winding groups 36, 38, 40, as well as of the entire machine 12. As will be appreciated by those skilled in the art, such insulation systems may include varnishes, tapes, sleeves, or combinations of such materials. The breakdown in such systems may result in partial or total failure in one or more conductors, windings, or groups of windings. Moreover, it should be noted that various types of machines may benefit from the present techniques, including motors and generators. Such machines may be wound in a variety of patterns, and interconnected in various manners, such as in wye and delta configurations, in various numbers of poles and in various numbers of winding groups. Similarly, insulation conditions may be detected and monitored both after degradation has occurred, as well as before significant degradation has occurred, such as by trending. Finally, as discussed below, the present techniques may be used to identify and even to localize insulation conditions in individual windings, groups of windings and in the entire machine.

In the embodiment illustrated in FIG. 2, the windings 36, 38 and 40 are provided with power via sets of power conductors or leads 42, 44 and 46, respectively. In the illustrated embodiment, the phase windings are coupled to a common ground 48. As illustrated, a plurality of differential current sensors 48, 50, 52, and voltage sensors 54, 56, 58 are provided for each phase, and associated with the power conductors 42, 44 and 46 for detecting the differential current through and voltage across the conductors. The current sensors are differential current sensors configured to generate feedback signals representative of instantaneous differential current through each winding. Similarly, the voltage sensors are adapted to measure the instantaneous phase voltage across the windings and corresponding neutral point. Output from the sensors is provided to the data acquisition system 18, and there through, to the processing module 20. As discussed below, based upon these sensed parameters, processing module 20 evaluates the condition of insulation of the windings.

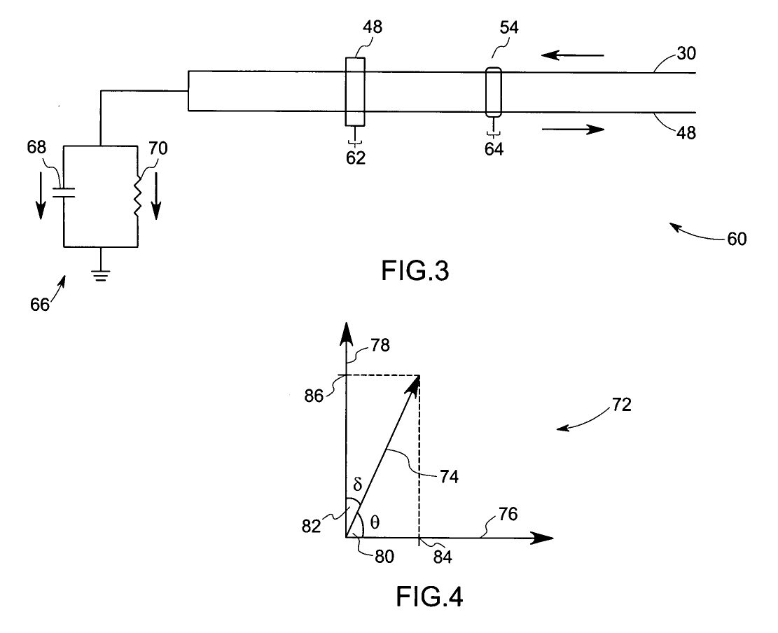

FIG. 3 is a diagrammatical illustration 60 of an equivalent circuit for a winding insulation system in one of the phases of the system shown in FIG. 2. As illustrated, the current sensor 48 provides an instantaneous differential current signal, as indicated by reference numeral 62. Similarly, voltage sensor 54 generates a signal representative of the instantaneous phase voltage, as indicated by reference numeral 64. An equivalent circuit 66 for the winding or winding group insulation includes a capacitance 68 and a resistance 70 coupled electrically in parallel as shown.

In accordance with the present techniques, and with the diagram of FIG. 3, a total current input to the winding, as indicated by the arrow adjacent to phase conductor 30 includes the sum of the load current drawn by the winding, and the current applied to the insulation system, including the current through the capacitance 68 and the resistance 70. The current exiting the winding, as indicated by the arrow adjacent to common conductor 48 includes the current applied to the insulation system only, including that of the capacitance 68 and the resistance 70.

Based upon the sensed instantaneous differential currents and voltages, then, these currents may be computed and separated, with phasor angular relationships between them used to provide an indication of the state of the winding insulation system. FIG. 4, is a phasor diagram 72 illustrating the total differential current 74 between the phase conductor and common conductor shown in the model of FIG. 3. The phasor quantity is illustrated graphically with respect to a voltage axis 76 and current axis 78. As shown, the total differential current 74 may be resolved into the resistive component 84 due to the equivalent resistance 70 and the capacitive component 86 due to the equivalent capacitance 68 as shown in FIG. 4. An angle θ, indicated by reference numeral 80, is the phase angle between the total differential current 74 and the phase voltage 84. The complement of the angle θ, indicated by the angle δ and reference numeral 82 in FIG. 4 provides an indication of insulation condition, as discussed below. For each phase, and for each winding or group monitored, then, the total differential current 74 consists of a resistive current component 84 and a capacitive current component 86.

A dissipation factor may be defined as the measure of the degree of electrical loss due to imperfect nature of the insulation condition of an electrical system. The dissipation factor, which may be computed as the tangent of the angle δ, is determined from the ratio of the resistive current component 84 to the capacitive current component 86. Degradation, damage, or contamination of the insulation results in changes of the desired parameters, culminating in an increase in angle δ, and a decrease in angle θ, resulting from an increase in differential current and an increase in resistive current loss. Unlike known systems, however, the present techniques permit monitoring of such parameters and conditions during operation of the machine, without requiring that the machine be shutdown.

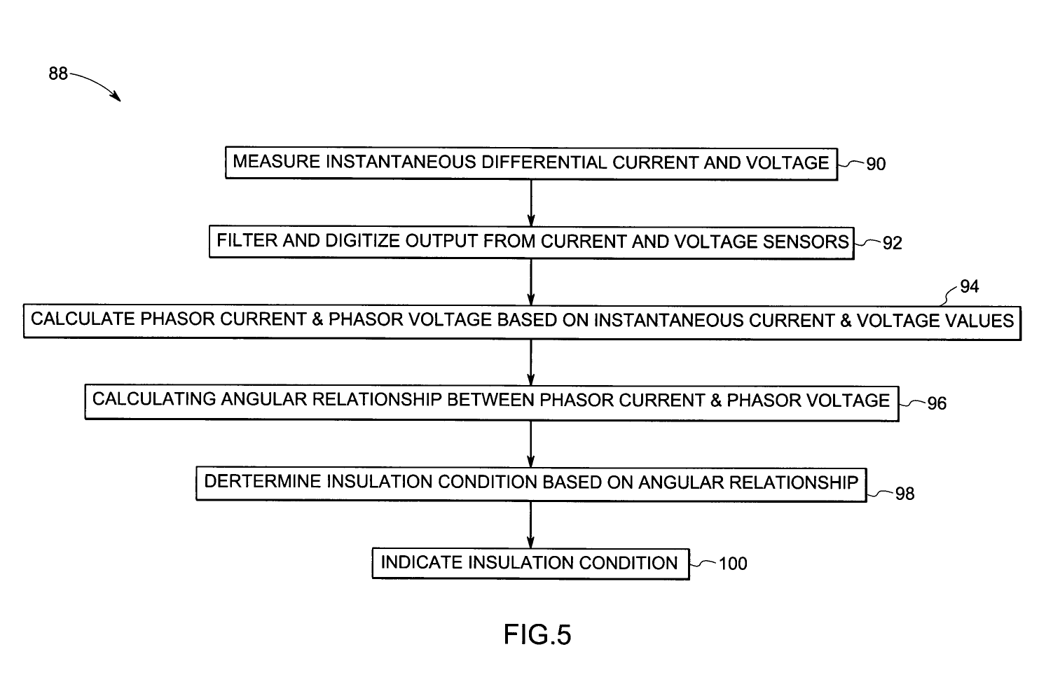

FIG. 5 is a flow chart illustrating exemplary steps involved in insulation condition monitoring via a system of the type shown in FIG. 1. The general analytical process, designated by the reference numeral 88, begins with measurement of values for the instantaneous differential current and the instantaneous phase voltage during operation of the machine, as indicated at reference numeral 90. These parameters are measured via the differential current sensors and the voltage sensors, respectively. At step 92, the output from the current sensors and the voltage sensors is filtered and digitized as discussed above. At step 94, the values for instantaneous differential current and instantaneous differential voltage are converted to respective values for phasor current and phasor voltage via a processing module. At step 96, an angular relationship between the phasor current and phasor voltage is calculated and at step 98 an output is generated based on the angular relationship as an indication of insulation condition via the processing module. As discussed above, in a present embodiment, the tangent of the angle δ provides an indication of the insulation system condition. The output generated from the processing module, is stored in a memory module. At step 100, the output of the processing module is compared to a predetermined threshold value and an alert is generated when the output of the processing module exceeds the threshold value, via the indicator module. The value used for the comparison will generally depend upon empirical conditions, and may be determined on a winding, winding group or machine basis for each application. Moreover, as noted above, the indications may be analyzed, such as by trending, to determine and anticipate needs for servicing the machine and windings. As also above, where monitoring is provided for individual windings or winding groups, the analysis may include localization of degradation of the insulation system of one or more particular windings or winding groups.

One advantage of the present technique is that the insulation condition monitoring system does not require specialized equipment and does not depend for interpretation on the skill of an operator. The monitoring system could be based on utilizing current and voltage sensors, thereby enabling easy retrofitting to existing machines. Another advantage of the monitoring system is that the system could be used “online,” while the machine is under operation. Other benefits of the present insulation monitoring techniques includes non-invasive measurement, using trending to detect incipient winding failures for condition based maintenance, application to all single phase or three phase electric machines including motors, generators, and power transformers for insulation condition monitoring.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An insulation condition monitoring method for a rotating electric machine, the method comprising:
measuring a first set of values for an instantaneous differential current and an instantaneous phase voltage during operation of the machine;
calculating a second set of values for a phasor current and a phasor voltage based upon the first set of values of the instantaneous differential current and the instantaneous phase voltage, respectively;
calculating an angular relationship between the phasor current and phasor voltage; and
determining insulation condition based on the angular relationship.

2. The method of claim 1, further comprising determining at least one desired parameter from the angular relationship between the phasor current and the phasor voltage.

3. The method of claim 2, wherein the at least one desired parameter includes a phase angle between the differential phasor current and the phasor voltage.

4. The method of claim 2, wherein the at least one desired parameter includes an AC insulation resistance value.

5. The method of claim 2, wherein the at least one desired parameter includes a dissipation factor.

6. A method of operating an insulation condition monitoring system, the method comprising:
measuring a first set of values for an instantaneous differential current and an instantaneous phase voltage during operation of the machine;
calculating a second set of values for a phasor current and a phasor voltage based upon the first set of values of the instantaneous differential current and the instantaneous phase voltage, respectively;
calculating an angular relationship between the phasor current and phasor voltage;
calculating at least one desired parameter based on the angular relationship between the phasor current and the phasor voltage for determining insulation condition.

7. The method of claim 6, wherein the values for the instantaneous differential current and the instantaneous phase voltage are measured via a differential current sensor and a voltage sensor respectively.

8. The method of claim 6, wherein the at least one desired parameter includes a phase angle between the differential phasor current and the phasor voltage.

9. The method of claim 6, wherein the at least one desired parameter includes an AC insulation resistance value.

10. The method of claim 6, wherein the at least one desired parameter includes a dissipation factor.

11. The method of claim 7, further comprising filtering and digitizing the output from the current sensor and the voltage sensor.

12. An insulation condition monitoring system for a rotating electric machine, the system comprising:
a differential current sensor coupled to the rotating electric machine for measuring values of instantaneous differential current;
a voltage sensor coupled to the rotating electric machine for measuring values of instantaneous phase voltage; and
a processing module coupled to the current sensor and the voltage sensor, the processing module being configured for converting the values for instantaneous differential current and instantaneous phase voltage to respective values for phasor current and phasor voltage, and wherein the processing module is further configured to calculate an angular relationship between the phasor current and phasor voltage and generating an output based on the angular relationship as an indication of insulation condition.

13. The system of claim 12, further comprising a data acquisition system for filtering and digitizing the output from the differential current sensor and the voltage sensor.

14. The system of claim 12, further comprising a memory module for storing the output generated from the processing module.

15. The system of claim 14, further comprising an indicator module coupled to the processing module via the memory module, the indicator module configured to indicate the insulation condition based on the output from the processing module.

16. The system of claim 15, wherein the indicator module compares the output of the processing module to a predetermined threshold value.

17. The system of claim 16, wherein the indicator module generates an alert when the output of the processing module exceeds the predetermined threshold value.

18. A rotating electric machine comprising:
stator and rotor windings configured to conduct electric current and generate magnetic field by virtue of flow of the current;
plurality of conductors to conduct electric current to the windings;
an insulation system for insulating the windings;
an insulation condition monitoring system including:
a differential current sensor coupled to the rotating electric machine for measuring values of instantaneous differential current of at least one winding;
a voltage sensor coupled to the rotating electric machine for measuring values of instantaneous phase voltage of the at least one winding; and
a processing module coupled to the current sensor and the voltage sensor, the processing module being configured to convert the values for instantaneous differential current and instantaneous phase voltage to respective values for phasor current and phasor voltage, and wherein the processing module is further configured to calculate an angular relationship between the phasor current and phasor voltage and generating an output based on the angular relationship as an indication of insulation condition.

19. The machine of claim 18, further comprising a data acquisition system for filtering and digitizing the output from the differential current sensor and the voltage sensor.

20. The machine of claim 18, further comprising a memory module for storing the output generated from the processing module.

21. The machine of claim 20, further comprising an indicator module coupled to the processing module via the memory module, the indicator module configured for indicating the insulation condition based on the output from the processing module.

22. The machine of claim 18, wherein the machine comprises a single phase rotating machine.

23. The machine of claim 18, wherein the machine comprises a three phase rotating machine.

24. The machine of claim 18, wherein insulation condition is monitored for individual circuits per phase.

25. The machine of claim 18, wherein insulation condition is monitored for each coil.

26. The machine of claim 18, wherein insulation condition is monitored for the entire machine.

27. The machine of claim 21, wherein the indicator module compares the output of the processing module to a predetermined threshold value.

28. The machine of claim 27, wherein the indicator module generates an alert when the output of the processing module exceeds the threshold value.

29. An insulation condition monitoring system for a rotating electric machine, the system comprising:
means for measuring a first set of values for an instantaneous differential current and an instantaneous differential voltage;
means for calculating a second set of values for a phasor current and a phasor voltage based upon the first set of values of the instantaneous differential current and the instantaneous phase voltage, respectively;
means for calculating an angular relationship between the phasor current and phasor voltage; and
means for determining insulation condition based on the angular relationship.

30. A computer program for monitoring insulation condition of a rotating electric machine, the computer program comprising:
a routine for calculating a second set of values for a phasor current and a phasor voltage based upon a first set of values of an instantaneous differential current and an instantaneous phase voltage of the rotating machine, respectively;
a routine for calculating an angular relationship between the phasor current and phasor voltage; and
a routine for determining insulation condition based on the angular relationship.
